(19) United States
(12) Patent Application Publication
(10) Pub. No.: US 2013/0155707 A1
(43) Pub. Date: Jun. 20, 2013

(54) ANISOTROPIC INCANDESCENT LIGHT SOURCE

(71) Applicants: Istvan MUDRA, Budapest (HU); Laszlo Nagy, Budapest (HU); Jozsef Gallai, Budapest (HU)

(72) Inventors: Istvan MUDRA, Budapest (HU); Laszlo Nagy, Budapest (HU); Jozsef Gallai, Budapest (HU)

(21) Appl. No.: 13/327,167

(22) Filed: Dec. 15, 2011

(51) Int. Cl. B60Q 1/04; H01K 1/14

(52) U.S. Cl. 362/487; 313/113

(57) ABSTRACT

An improved incandescent light source as may be used in a vehicle headlamp for providing forward illumination. The illuminating system includes a filament coil and an anisotropic reflector assembly. The filament coil is constructed from a coil of wire that is electrically conductive and has a high melting point and the primary axis of the coil of wire is substantially aligned with a principal axis of the reflector system. The light flux emitted by the filament coil toward the reflector system is rotationally anisotropic.

### BACKGROUND

1. Field of the Invention

The aspects of the present disclosure relate generally to incandescent light sources, and in particular to filament structures for use in tungsten halogen automobile headlamps.

2. Description of Related Art

Headlamps, such as those used to provide forward lighting in automobiles and other types of vehicles, generally provide illumination along the direction of travel.

One common type of automotive headlamp in use today generates light from an incandescent source. These headlamps generate light by passing electricity through a length of resistive wire, called a filament, causing it to heat up to a very high temperature and emit light. Typical filaments for automotive headlamps are formed by coiling a wire of a suitable material, usually tungsten, to form a substantially circular coil with each individual coil, i.e. turn, of wire separated from the next coil by a distance less than the width of the Langmuir sheath. Generally speaking, the Langmuir sheath is a layer of stationary gas, about 0.4 cm thick, which exists around nearly all heated filaments. Since its diameter is fairly constant, the length of the Langmuir sheath is kept short to minimize the transfer of heat from the filament through the Langmuir sheath. The resulting coil filament is circular in cross-section and rotationally symmetrical. A single-coil is formed when a filament is wound into a series of loops as described above. A coiled-coil is a structure in which this single-coil is itself wound into a larger coil. This larger coil is also circular in cross-section and rotationally symmetrical.

In order to generate more light from incandescent lamps, the temperature of the filament must be increased. The higher the temperature the more light that is generated. However, the higher temperatures can adversely affect filament life by, for example, accelerating the rate of evaporation of the filament material, usually tungsten. Surrounding the filament with a transparent envelope and filling the envelope with a small amount of a halogen compound, such as iodine or bromine, along with an inert filler gas causes the evaporated tungsten to be re-deposited on the filament rather than on the transparent envelope greatly increasing the filament's life. However, the filler gas causes convective cooling of the filament thereby reducing its efficacy.

Studies have shown that brighter headlamps significantly improve a driver's ability to detect and recognize objects in the roadway in front of them. It is therefore advantageous to create brighter and safer headlamps. While brighter automobile headlamps improve a driver's vision, there are many factors that limit how bright an automobile headlamp can be, such as glare to which oncoming traffic and pedestrians are subjected, power consumption, fuel economy and governmental regulation. Thus, there exists a need for brighter headlamps that conform to existing regulations and standards and do not consume additional energy.

Typical automotive headlamps employ anisotropic reflectors in which the side portions of the reflectors use light more efficiently than the top and bottom portions. However, the light sources used are isotropic, resulting in a significant amount of light flux being wasted on the less efficient top and bottom portions of the reflector.

Accordingly, it would be desirable to provide a light source for automobile headlamps that solve at least some of the problems identified above.

### SUMMARY OF THE INVENTION

As described herein, the exemplary embodiments overcome one or more of the above or other disadvantages known in the art.

One aspect of the present disclosure relates to an illuminating system. The illuminating system includes a filament and an anisotropic reflector assembly. The filament is constructed from a coil of wire that is electrically conductive and has a high melting point. As one example, the “high melting point” of pure tungsten is 3,422 degrees Celsius (or 6,192 degrees Fahrenheit). A longitudinal, primary axis of the coil of wire is substantially aligned with a principal axis of the reflector system so that the light flux emitted by the filament toward the reflector system is rotationally anisotropic.

Another aspect of the present disclosure relates to an incandescent lamp. The incandescent lamp includes a filament, a substantially transparent envelope enclosing the filament having a first end and a second end, and a cap fixedly attached to the first end of the envelope. The filament is constructed of a coil of wire that is electrically conductive and has a high melting point, and is shaped and/or positioned so that its emitted light flux is rotationally anisotropic. The cap is configured to hold the filament in a fixed orientation, with the primary axis of the coil of wire being substantially aligned with a principal axis of an anisotropic reflector assembly.

Another aspect of the present disclosure relates to a vehicle headlamp assembly that includes an incandescent lamp, an anisotropic reflector assembly having a principal axis, and a housing. The incandescent lamp includes a filament coil, a substantially transparent envelope enclosing the filament coil having a first end and a second end, and a cap fixedly attached to the first end of the envelope. The filament coil is constructed of a coil of wire that is electrically conductive and has a high melting point, and the light flux emitted by the coil of wire toward the reflector system is rotationally anisotropic. The cap is removably coupled to the housing and configured to hold the filament coil in a fixed orientation within the reflector such that the primary axis of the coil of wire is substantially aligned with the principal axis of the reflector system.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates a light source and reflector incorporating aspects of the present disclosure;

FIG. 2 illustrates flux contributions to the beam hotspot from typical automotive reflectors;

FIG. 3 illustrates a cross-section of an oval shaped filament coil incorporating aspects of the present disclosure;

FIG. 4 illustrates a perspective view of an oval single-coil filament incorporating aspects of the present disclosure;

FIG. 5 illustrates a cross-section of a rounded rectangle filament coil incorporating aspects of the present disclosure; and

FIG. 6 illustrates a perspective view of a rounded rectangle single-coil filament incorporating aspects of the present disclosure.

### DETAILED DESCRIPTION OF THE DISCLOSED EMBODIMENTS

Aspects of the disclosed embodiments are directed to an anisotropic light source that may be used in a light source assembly or headlamp assembly for a vehicle. Although the aspects of the disclosed embodiments will generally be described herein with respect to an automobile, the aspects of the disclosed embodiments are not so limited and can include any suitable transportation application where an anisotropic light source may be utilized. These can include for example, landing lights, flood lights, spot lights, and other suitable transportation lighting applications for land, sea, air and/or space.

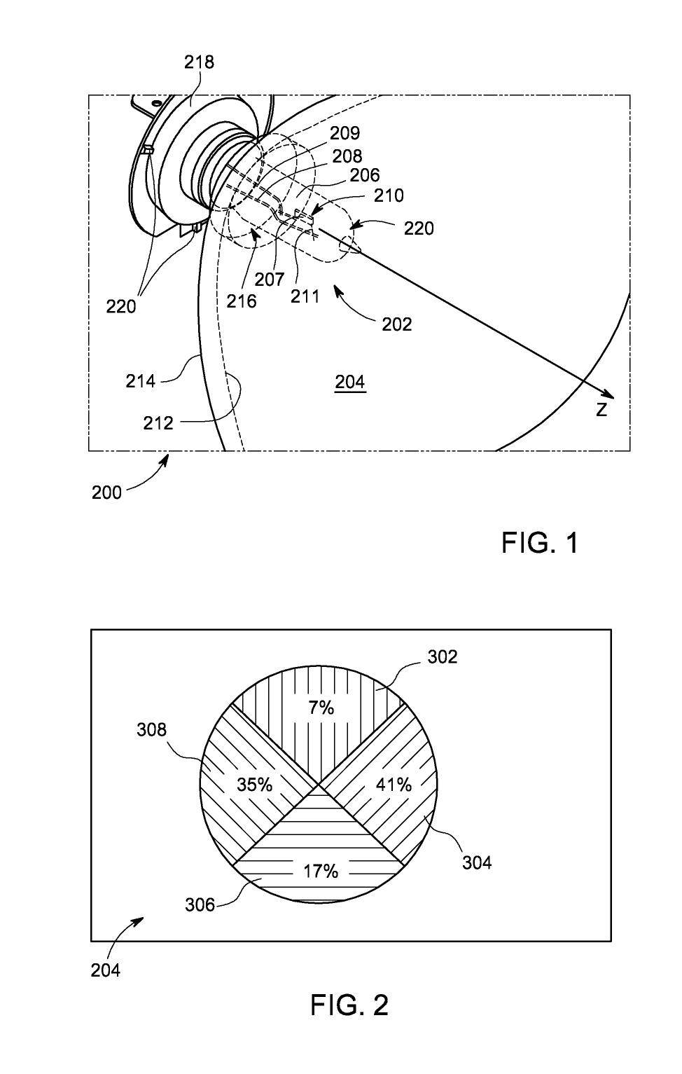

FIG. 1 illustrates an exemplary headlamp assembly 200, of which an exemplary light source assembly 202 may form a part. Embodiments of the anisotropic light source assembly 202 generally include a filament coil 210 that is longitudinally aligned with a primary optical axis Z of the headlamp assembly 200. To leverage asymmetries commonly found in headlamp reflectors, the filament coil 210 of the anisotropic light source does not have a rotationally symmetric cross-section. As used herein, the term “rotationally asymmetric” refers to a shape whose height generally greater than its width, for example an oval and a rectangle are “rotationally asymmetric” while a circle and a square are rotationally symmetric. Rather, in one embodiment, a height of the filament coil 210 is greater than its width so that more of its emitted light flux travels toward the side portions or quadrants of the reflector 204 than toward its top and bottom portions, thereby producing a brighter beam for the same amount of emitted light flux.

As shown in FIG. 1, light source assembly 202 generally comprises a sealed envelope or bulb 206 containing the filament coil 210. The filament coil ends 207, 211 are attached to a set of leads 208, 209. The leads 208, 209 are typically formed from a sturdier conductive metal, which in the embodiment illustrated in FIG. 1 is a heavier gauge wire, and provide support for the filament coil ends 207, 211 and supply electric current to the filament coil 210. The leads 208, 209 are arranged such that they support the filament coil 210 in a desired orientation within an anisotropic reflector assembly 204 (hereinafter, “reflector assembly 204”).

The reflector assembly 204 is mounted around the light source 202 to reflect light generated by the filament coil 210 generally along the primary optical axis Z. In some embodiments the reflector assembly is a generally parabolic concave mirror with the principal axis of the concave mirror forming the primary optical axis of the headlamp assembly 200. As used herein, “primary optical axis Z” refers to the direction in which a beam of light travels upon emanating from the light assembly 200, and corresponds to the principal axis of the reflector assembly 204. The primary optical axis Z is generally located along the direction of travel of the vehicle to which the headlamp assembly 200 is mounted. The reflector assembly 204 is constructed of a suitable material such as glass or plastic and has a material coating its front 212 surface and/or rear 214 surface that will reflect at least that portion of light generated by the filament coil 210 that falls within the visible region of the electromagnetic spectrum.

In automotive applications the reflector assembly 204 can be typically rotatably mounted (not shown) such that it can rotate about the horizontal and vertical axes to allow the primary optical axis Z to be properly aligned with the direction of travel of the automobile.

The reflector assembly 204 is comprised of one or more generally parabolic sections configured to form the reflected light into a desired illumination area. Alternatively the reflector assembly 204 may comprise a single parabolic element, discrete reflective elements, smoothly transitioning reflective elements. One skilled in the art will recognize that any reflector assembly 204 that creates a suitable illumination pattern may be used without straying from the spirit and scope of the present disclosure.

An opening 216 in the optical center of the reflector assembly 204 is configured to accept the light source assembly 202. The light source 202 may include: a transparent or translucent envelope 206 that encapsulates the filament coil 210 and/or the filament coil ends 207, 211, which are electrically coupled to leads 208, 209. In one embodiment, a gaseous mixture is trapped within the interior of the envelope 206. This gaseous mixture may comprise a halogen compound, such as for example iodine or hydrocarbon bromine compounds, mixed with an inert fill-gas which is above atmospheric pressure.

The filament coil 210 may comprise a high melting point low vapor pressure metal wire, preferably tungsten. The envelope 206 may be formed of a material such as fused silica, having suitable optical and thermal qualities and/or of a material such as aluminosilicate glass having a high melting point.

The set of leads 208, 209 support the filament coil ends 207, 211 thereby holding the filament coil 210 in the proper location and orientation. The filament coil 210 can be formed as a single-coil or coiled-coil of wire, and is mounted with its longitudinal axis parallel to, or substantially parallel to, the Z-axis. As will be discussed in more detail below, the filament coil 210 of the disclosed embodiments does not have a rotationally symmetric cross-section, and a height of the filament coil 210 is greater than its width.

In one embodiment the envelope 206 is fixedly attached to an end cap 218, which is configured to mount the light source assembly 202 into a headlamp housing (not shown). The end cap 218 includes various alignment means 220 configured to be mated with the corresponding headlamp housing (not shown) to retain the light source assembly 202 in a fixed orientation with respect to the reflector assembly 204. The end cap 218 when installed in a standardized holder (not shown), or suitable headlamp housing (not shown) will properly position and orient the lamp 202 within the reflector 204 such that the primary axis of the filament coil 210 is aligned with the optical axis Z of the headlamp assembly 200.

As described above, the reflector assembly 204 is used to redirect anisotropic light flux generated by the filament coil 210 to form a beam of light which will provide a desired illumination pattern. Typical illumination patterns comprise a hotspot or an area of peak brightness near the middle of the illumination pattern with beam brightness gradually reduced at points farther away from the hotspot. In some embodiments the front portion 220 of the envelope 206 is coated with an opaque material to prevent uncontrolled light from corrupting the desired beam pattern created by the reflector assembly 204.

FIG. 2 illustrates a pictorial depiction of an exemplary anisotropic reflector assembly 204, which means that different portions of the reflector assembly 204 contribute different amounts of light to the illumination pattern.

To illustrate this, the headlamp reflector assembly 204 has been divided into four quadrants, generally described as upper quadrant 302, lower quadrant 306, right quadrant 304 and left quadrant 308 (hereinafter “quadrants 302-308”), as shown in FIG. 2. The different quadrants 302-308 of the reflector 204 surface contribute different amounts of light to the hotspot region of the beam.

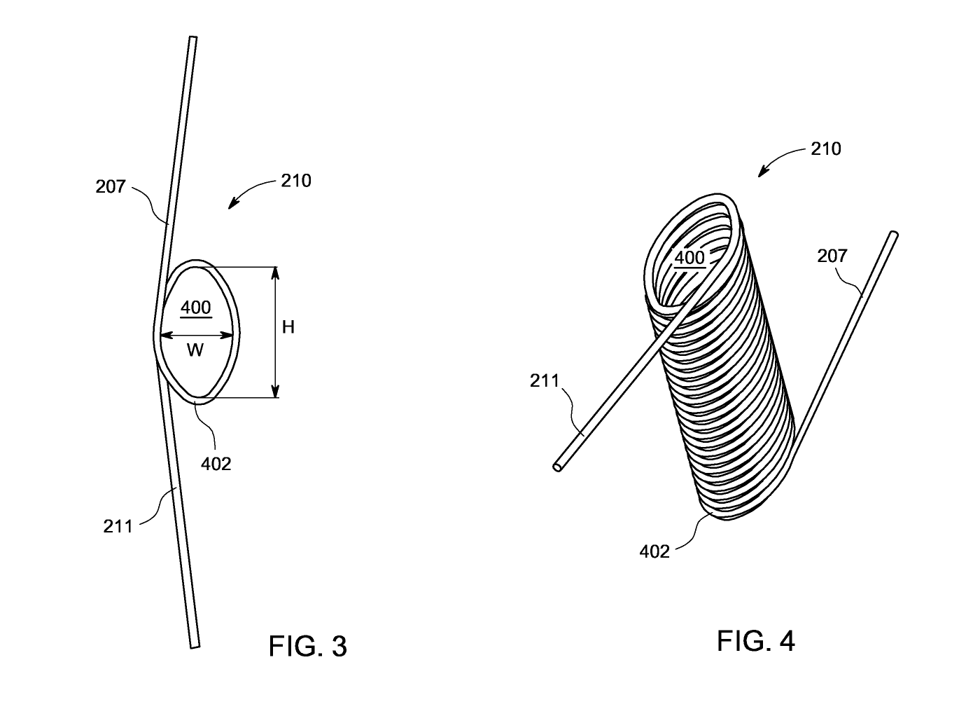

Experiments performed to measure the amount of light various quadrants of the reflector assembly 204 contribute to the hotspot clearly demonstrate the anisotropic nature of headlamp reflector assemblies 204. In the experiments for determining reflector beam contribution, the amount of flux each reflector assembly quadrant 302-308 contributed to the hotspot was measured and recorded as a percentage of the total flux of the hotspot. Table 1 shows the results from five typical automotive reflector assemblies along with average values. Taking the average of all tested automotive reflector assemblies yielded the average contribution of light flux to the hot spot for each of the quadrants 302-308 to be: upper 302=7%; lower 306 17%; right 304=41%; and left 208=35%. These average contribution values are shown in their respective quadrants 302-308 in FIG. 3.

As can be seen from Table 1 below, the majority of light flux (76.7%) is contributed to the hotspot by the left quadrant 308 and the right quadrant 304. It should be noted that the relative contribution of the left quadrant 308 and the right quadrant 304 may be swapped in reflectors designed for use in left-traffic or right-traffic countries. However the side quadrants 304, 308 of the reflector assembly 204 will always contribute a majority of the light flux as compared to the top 302 and bottom 306 portions of the reflector. These experiments show that a light source with an anisotropic light distribution, such as the light source assembly 202 of the disclosed embodiments, that emits most of its light to the sides will provide superior illumination of the hotspot when compared to an isotropic light source of the same brightness that emits light uniformly in all directions.

TABLE 1
Hotspot flux contribution of reflector quadrants.

| | Refl. | Refl. | Refl. | Refl. | Refl. | | | |
|---|---|---|---|---|---|---|---|---|
| | I | II | III | IV | V | Avg. | Max. | Min. |
| Left (304) | 30.9 | 33.5 | 36.1 | 36.8 | 40.7 | 35.6 | 40.7 | 30.9 |
| Right (308) | 37.7 | 39.9 | 45.5 | 41.4 | 41.0 | 41.1 | 45.5 | 37.7 |
| Top (302) | 5.7 | 8.7 | 9.0 | 4.5 | 6.6 | 6.9 | 9.0 | 4.5 |
| Bottom (306) | 25.7 | 17.9 | 9.4 | 17.3 | 11.7 | 16.4 | 25.7 | 9.4 |
| Sides | 68.6 | 73.5 | 81.6 | 78.2 | 81.7 | 76.7 | 81.7 | 68.6 |
| Top-Bottom | 31.4 | 26.5 | 18.4 | 21.8 | 18.3 | 23.3 | 31.4 | 18.3 |

In one embodiment, a light source assembly 202 with an anisotropic light distribution is created by forming a filament coil 210 that does not have rotational symmetry. For example, a filament coil 210 formed with a cross section (perpendicular to the z-axis) that has a height, i.e. distance along the vertical x-axis, greater than its width, i.e. distance along the horizontal y-axis, will direct a greater amount of emitted light flux towards the side quadrants 304, 308 than toward the top quadrant 302 and the bottom quadrant 306.

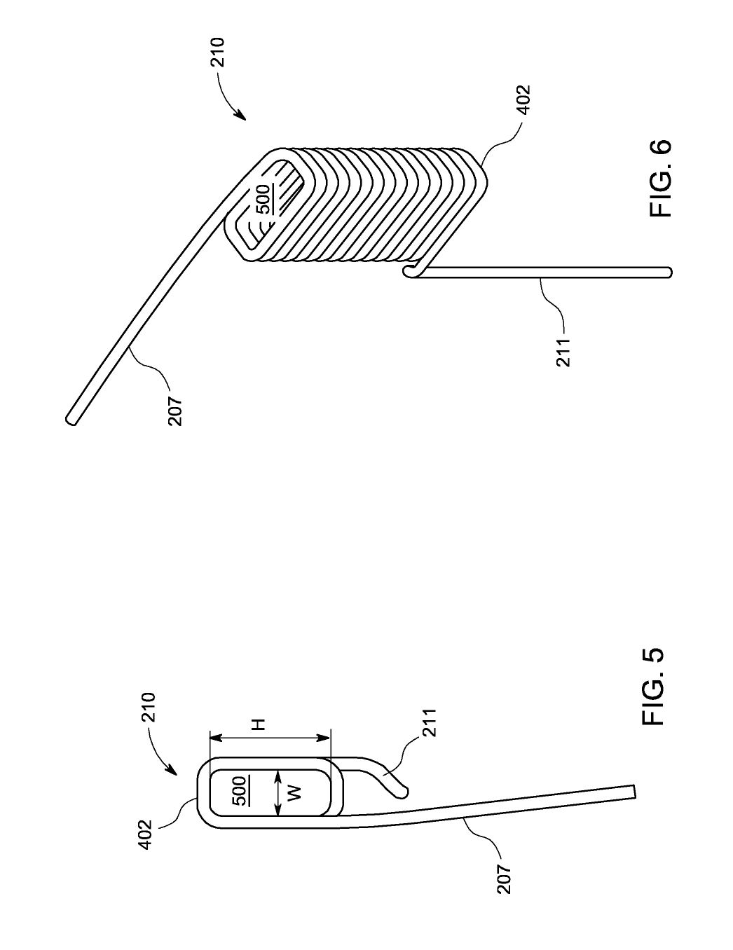

A filament coil 210 having its height greater than its width can be formed using cross-sections with various geometrical shapes such as for example an oval, as is illustrated in FIGS. 3 and 4 or a rounded rectangle as is illustrated in FIGS. 5 and 6. Those skilled in the art will recognize that other shapes may also be used to create a filament coil 210 with its height greater than its width.

Referring to FIG. 3, a filament coil 210 is shown that has an asymmetric cross-section formed as an oval shape 400 where the width W along the horizontal y-axis is less than the height H along the vertical x-axis, with the primary axis of the coil, i.e. optical axis or direction of travel, being substantially perpendicular to the page. The ends 207, 211 of the filament coil 210 are attached to the leads 208, 209 when the filament coil 210 is installed into the headlamp assembly 200 of FIG. 2. FIG. 4 shows a perspective view of the filament coil 210 shown in FIG. 3 which has an asymmetric cross-section formed as an oval shape 400.

FIG. 5 illustrates an alternative filament coil 210 having an asymmetric cross section where the cross-section of the coil has a rounded rectangular shape 500. As described above, the ends 207, 211 of the filament coil 210 are attached to the leads 208, 209 when the filament coil 210 is installed into the headlamp assembly 200. FIG. 6 shows a perspective view of the filament coil 210 shown in FIG. 5 which has an asymmetric cross-section formed as a rounded rectangular shape 500.

Prototypes of the filament coils 210 with oval 400 and rounded rectangular 500 shapes have been fabricated and tested. These tests demonstrated that headlamp assemblies 200 comprising filament coils 210 with their height greater than their width provide about a 4% to about a 25% average improvement over standard filament light sources. The rotationally unsymmetrical filament coils of FIGS. 3, 4, 5, and 6 preferably have a height to width ratio H/W of between 1.05 and 5 (1.05<=H/W<=5); however any filament coil 210 with a height H to width W ratio generally greater than 1.00 may be advantageous, and is within the spirit and scope of the present disclosure.

The filament coils 210 shown in FIGS. 1, and 3-6 are generally shown and described as single-coil filaments. However, it is contemplated to replace the filament wire 402 with a single-coil of wire having an outer diameter similar to the gauge of the single-coil filament wire 402, thereby forming a coiled-coil filament, as that term is generally understood. Forming this coiled-coil filament with the coil cross-section geometries described above, such as the oval shape 400 or rounded rectangular shape 500, results in coiled-coil filaments exhibiting the same anisotropic light emissions with increased efficiency.

In addition to the rotational asymmetry described above, another contributor to anisotropic distribution of light from the light source assembly 202 is the location of the leads 208, 209 used to hold the filament coil 210 in place. The leads 208, 209, which are formed as wires in the embodiment illustrated in FIG. 1, block a small but significant amount of light flux emanating from the filament coil 210. By placing the leads 208, 209 above or below the filament coil 210, the leads 208, 209 do not block light flux that is emanating toward the sides, i.e. higher contributing left quadrant 308 and right quadrant 304 of the reflector 204, thereby minimizing degradation of the hotspot intensity caused by the leads 208, 209. In the embodiment shown in FIG. 2, the longer lead 208 used to support the forward end 211 of the filament coil 210 is placed below the filament coil 210 and the shorter lead 209 used to support the rearward end 207 of the filament coil 210 is positioned above the longer lead 208 and above and behind the filament coil 210. Placing the lead 208 below the filament coil 210 rather than above it also minimizes heating of the lead 208 by the filament coil 210 thus reducing the risk of thermal damage to the lead 208. Alternatively, it is advantageous in certain embodiments to place the longer lead 208 above the filament coil 210.

The aspects of the disclosed embodiments provide an anisotropic light source assemble 202 that directs more of its emitted light toward one or more areas 304, 308 of a reflector assembly 304 that contribute more (or the greatest amount of) light flux to a hotspot region of a light beam than one or more other areas 302, 306 of the reflector assembly. The anisotropic light source assembly 202 of the disclosed embodiments generally includes filament coil 210 with a cross-section that is rotationally asymmetric. The rotationally asymmetric filament coil 210 is aligned with the optical axis of a headlamp assembly 200 and emits an anisotropic light distribution that leverages asymmetries in reflector assemblies, which can be used in automobile headlamps. Advantageously, embodiments of the anisotropic light source assembly 202 described herein will produce a brighter light beam for generally the same amount of emitted flux than conventional isotropic light source assemblies.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit and scope of the invention. Moreover, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An illuminating system, comprising:
an anisotropic filament coil comprising a coil of wire that is electrically conductive and that as a longitudinal axis; and
an anisotropic reflector assembly having a principal axis,
wherein the longitudinal axis of the coil of wire is substantially aligned with the principal axis of the anisotropic reflector assembly, and
wherein a light flux emitted by the anisotropic filament coil toward the anisotropic reflector assembly is rotationally anisotropic.

2. The illuminating system of claim 1 wherein the anisotropic reflector assembly comprises an upper quadrant, a lower quadrant, and right quadrant and a left quadrant, and
the anisotropic reflector assembly is configured such that the right and left quadrants reflect a greater portion of the flux than the upper and lower quadrants.

3. The illuminating system of claim 2 wherein the anisotropic filament coil emits a greater portion of the flux toward the right and left quadrants than toward the upper and lower quadrants.

4. The illuminating system of claim 3, wherein a cross-section of the coil of wire has a height and a width, the height being greater than the width.

5. The illuminating system of claim 4, wherein a shape of the cross-section of the coil of wire comprises an oval shape.

6. The illuminating system of claim 4, wherein a shape of the cross-section of the coil of wire comprises a rounded rectangular shape.

5. The illuminating system of claim 4, wherein the height of the cross-section of the coil of wire is between about 1.05 and about five times the width of the cross-section of the coil of wire.

7. The illuminating system of claim 3, wherein the coil of wire is a single-coil of wire.

8. The illuminating system of claim 3, wherein the coil of wire is a coiled-coil of wire.

9. The illuminating system of claim 3, wherein the anisotropic reflector assembly further comprises a generally parabolic reflector assembly.

10. An incandescent lamp, comprising:
an anisotropic filament coil;
a substantially transparent envelope enclosing the filament coil, the envelope having a first end and a second end; and
a cap fixedly attached to the first end of the envelope,
wherein the filament coil comprises a coil of wire that is electrically conductive, and wherein a light flux emitted by the coil of wire is rotationally anisotropic, and
the cap is configured to hold the anisotropic filament coil in a fixed orientation such that a longitudinal axis of the coil of wire is substantially aligned with a principal axis of an anisotropic reflector assembly.

11. The incandescent lamp of claim 10, wherein the coil of wire has a height and a width, the height of the cross-section of the coil of wire being greater than the width of the cross-section of the coil of wire, and the longitudinal axis of the coil of wire is substantially aligned with an optical axis of the lamp.

12. The incandescent lamp of claim 11, wherein a shape of the cross-section of the coil of wire comprises an oval shape.

13. The incandescent lamp of claim 11, wherein a shape of the cross-section of the coil of wire comprises a rounded rectangular shape.

14. The incandescent lamp of claim 11, wherein the height of the cross-section of the coil of wire is between about 11.05 and about five times the width of the cross-section of the coil of wire.

15. The incandescent lamp of claim 11, wherein the filament coil comprises a single-coil of wire.

16. The incandescent lamp of claim 11, wherein the filament coil comprises a coiled-coil of wire.

17. The incandescent lamp of claim 11, wherein the anisotropic reflector assembly comprises a generally parabolic reflector assembly.

18. An automotive headlamp assembly, the assembly comprising:
an incandescent lamp;
an anisotropic reflector assembly having a principal axis; and
a housing,
wherein the lamp comprises:
an anisotropic filament coil;
a substantially transparent envelope enclosing the filament coil, the envelope having a first end and a second end; and
a cap fixedly attached to the first end of the envelope,
wherein the anisotropic filament coil comprises a coil of wire that is electrically conductive, and wherein a light flux emitted by the coil of wire toward the anisotropic reflector assembly is rotationally anisotropic, and
wherein the cap is removably coupled to the housing and configured to hold the anisotropic filament coil in a fixed orientation within the anisotropic reflector assembly such that longitudinal axis of the coil of wire is substantially aligned with a principal axis of the anisotropic reflector assembly.

19. The automobile headlamp assembly of claim 18, wherein a cross-section of the coil of wire has a height and a width, the height of the cross-section of the coil of wire being greater than the width of the cross-section of the coil of wire.

20. The automobile headlamp assembly of claim 19, wherein a shape of the cross-section of the coil of wire comprises an oval shape.

21. The automobile headlamp assembly of claim 19, wherein a shape of the cross-section of the coil of wire comprises a rounded rectangular shape.

22. The automobile headlamp assembly of claim 19, wherein the height of the cross-section of the coil of wire is between about 1.05 and about five times the width of the cross-section of the coil of wire.
